(19) United States
(12) Patent Application Publication
(10) Pub. No.: US 2010/0214571 A1
(43) Pub. Date: Aug. 26, 2010

(54) DRAG-AND-DROP PRINTING METHOD WITH ENHANCED FUNCTIONS

(75) Inventor: Qi LUO, San Mateo, CA (US)

Correspondence Address: Chen Yoshimura LLP;Attention Ying Chen, 333 W. El Camino Real, Suite 380, Sunnyvale, CA, 94087, US

(73) Assignee: KONICA MINOLTA SYSTEMS LABORATORY, INC., Huntington Beach, CA (US)

(21) Appl. No.: 12/394,022

(22) Filed: Feb. 26, 2009

(51) Int. Cl. G06F 3/12; G06F 3/048

(52) U.S. Cl. 358/1.1; 715/769

(57) ABSTRACT

A drag-and-drop direct printing method with enhanced functions is described. A printing bin icon is provided on the computer's desktop, and the user drags files onto the icon to print the files without manually opening them. The printing bin program allows a user to set basic printing property settings, select a printer, compose a page, etc. all without visibly opening the files or the full printing and print properties interface. Simple popup menus, such as a printing property setting menu, printer selection menu, page composition menu, etc. are provided to allow the user to accomplish these functions. In one embodiment, when a user drops a file in the printing bin icon, a popup menu allows the user to select one of multiple printing methods, such as print with current settings, change settings and print, select printer and print, compose page and print, etc.

### BACKGROUND OF THE INVENTION

1. Field of the Invention

This invention relates to a method of printing files, and in particular, it relates to a drag-and-drop printing method with enhanced functions.

2. Description of Related Art

Methods have been developed to provide users with convenient ways to print files with fewer operation steps. Often, a user already has his files ready to print and does not need to modify the contents of the files before printing. A direct printing method (or “drag-and-drop” printing method), allows the user to drag a file onto a printer icon to print it. The print program represented by the printer icon will automatically call the file's associated application (e.g., it will call the Microsoft Word application for a .doc file), although the application may not be visibly open to the user, then print the file to the printer associated with the printer icon using previously saved printing property settings of the printer. However, if the user wishes to change printing property settings such as copy number, color mode, duplex mode, etc., the user has to open the associated application for each file and open the printer setting user interface (UI) to set printing property settings before printings. This operation is not convenient to users.

### SUMMARY

Accordingly, the present invention is directed to a drag-and-drop printing method that substantially obviates one or more of the problems due to limitations and disadvantages of the related art.

An object of the present invention is to allow a user to perform basic printing property settings and page composing while taking advantages of drag-and-drop printing.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented on a computer for printing a file, which includes: (a) displaying a printing bin icon representing a printing bin program; (b) in response to a file being dragged and dropped onto the printing bin icon, the printing bin program displaying a printing property settings menu indicating one or more printing property settings for printing the file; (c) receiving a user input entered via the printing property settings menu for setting the printing property settings; and (d) printing the file using the printing property settings set in step (c).

In another aspect, the present invention provides a method implemented on a computer for printing one or more files, which includes: (a) displaying a printing bin icon representing a printing bin program; (b) in response to a file being dragged and dropped onto the printing bin icon, the printing bin program displaying a printer selection menu indicating a plurality of printers associated with the printing bin icon; (c) receiving a user input entered via the printer selection menu for selecting one of the plurality of printers; and (d) printing the file using the printer selected in step (c).

In another aspect, the present invention provides a method implemented on a computer for printing a plurality of files, which includes: (a) displaying a printing bin icon representing a printing bin program; (b) in response to one of the plurality of files being dragged and dropped onto the printing bin icon, the printing bin program displaying a page composition menu including a page template; (c) receiving a user input entered via the page composition menu for forming a composed page, the composed page including one or more areas within the page template, each area containing one of the plurality of files; (d) generating a new file representing the composed page; and (e) printing the new file generated in step (d).

In another aspect, the present invention provides a method implemented on a computer for printing one or more files, which includes: (a) displaying a printing bin icon representing a printing bin program; (b) in response to one of the one or more files being dragged and dropped onto the printing bin icon, the printing bin program displaying a printing mode selection menu including two or more of: a print with current settings mode, a change settings and print mode, a select printer and print mode, and a compose page and print mode; (c) receiving a first user input entered via the printing mode selection menu selecting one of the printing modes; (d) displaying a second menu based on the selected printing mode, the second menu being one of a printing property settings menu including one or more printing property settings for printing the file, a printer selection menu including a plurality of printers associated with the printing bin icon, and a page composition menu including a page template; (e) receiving a second user input entered via the second menu; and (f) printing the one or more files based on the second user input received in step (e).

In another aspect, the present invention provides a computer program product comprising a computer usable medium having a computer readable program code embedded therein that causes a computer to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 illustrate a method for printing a file according to a first embodiment of the present invention.

FIG. 3 illustrates a method for changing printing property settings associated with a printing bin icon according to a second embodiment of the present invention.

FIG. 4 illustrates a method of selecting one of the printers associated with the printing bin icon for printing a file according to a third embodiment of the present invention.

FIG. 5 illustrates a method for composing a page of document and printing the composed page according to a fourth embodiment of the present invention.

FIG. 6 illustrates a printing method according to a sixth embodiment of the present invention which allows the user to print a file using the printer bin icon and selecting a printing mode.

FIG. 7 is a flow chart illustrating the method according to the sixth embodiment.

### DETAILED DESCRIPTION OF PREFERRED EMBODIMENTS

The printing methods according to embodiments of the present invention provide a drag-and-drop direct printing method with enhanced functions. In a drag-and-drop printing method, an icon style application (referred to as the printing bin herein) is provided and put on the operating system's desktop, and the user drags one or more files onto the printing bin icon without manually opening the file using the associated application. The files may be different type of files such as .doc, .xls, .ppt, .jpg, .bmp, .pdf, .ps, etc. The program represented by the printing bin icon uses the applications associated with the files to print the files automatically. The enhanced methods allow a user to perform basic printing property settings and composing while taking advantages of drag-and-drop printing.

In one embodiment, a user interface (UI) associated with the printing bin icon allows the user to conveniently set a number of frequently used printing property settings for the file being printed. In another embodiment, a UI associated with the printing bin icon allows the user to conveniently set and save a number of frequently used printing property settings for the printing bin. In another embodiment, a UI associated with the printing bin icon allows the user to select a printer from multiple printers associated with the printing bin to print the file. In another embodiment, a UI associated with the printing bin icon allows the user to compose a page by arranging multiple files on a page. In another embodiment, the printing bin icon is associated with multiple printers and implements a round-robin scheduling method to print multiple documents to multiple printers. In yet another embodiment, a UI associated with the printing bin icon allows the user to select one of the above printing methods. These embodiments are described in more detail below.

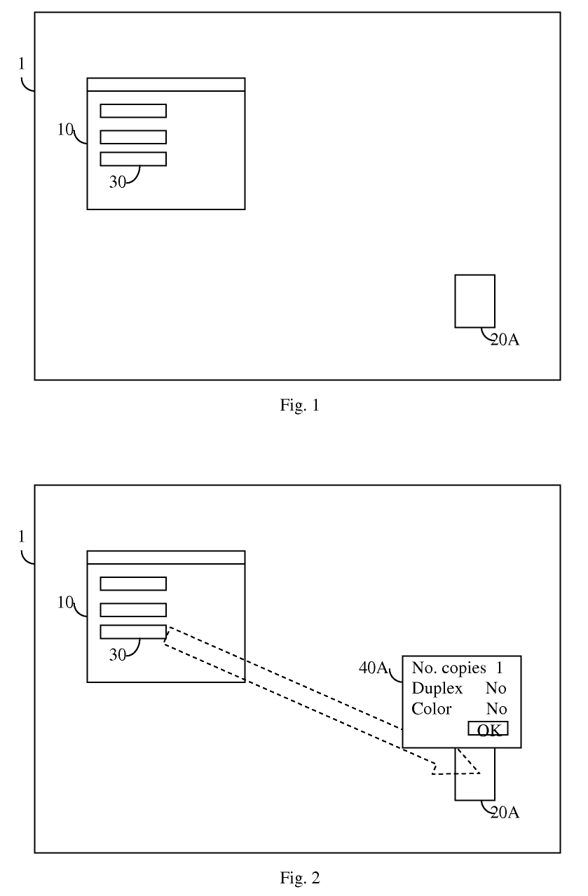

FIGS. 1 and 2 illustrate a method for printing a file according to a first embodiment of the present invention. As shown in FIG. 1, a desktop 1 is shown to display an open folder 10 containing a number of files 30, and a printing bin icon 20A which represents a program (the printing bin program). As shown in FIG. 2, to directly print one or more files 30, the user uses an input device such as a mouse to drag the file icons 30 from the folder 10 onto the printing bin icon 20A and drops it. In response to the file 30 being dropped onto the printer bin icon 20A, the printing bin program displays a printing property settings popup menu 40A adjacent the printing bin icon 20A. The printing property settings menu 40A is different from the settings menu provided by the printer driver program; it is a simplified menu and typically only includes a number of frequently used basic printing property settings, such as the number of copies to be printed, whether duplex is required, color or black and white mode, etc. The menu 40A preferably includes only one screen (i.e. does not contain buttons that will open a new screen and does not include multiple tabs). The user may set these printing properties, and click the “OK” button. Then, the printing bin program automatically invokes the file's associated application (although typically the file is not open on the desktop and not visible to the user), and print the file with the printing property settings just inputted by the user. Preferably, the printing property settings specified by using the popup menu 40A are temporary so that they will only control the printing of the current files and do not change the saved printing property settings.

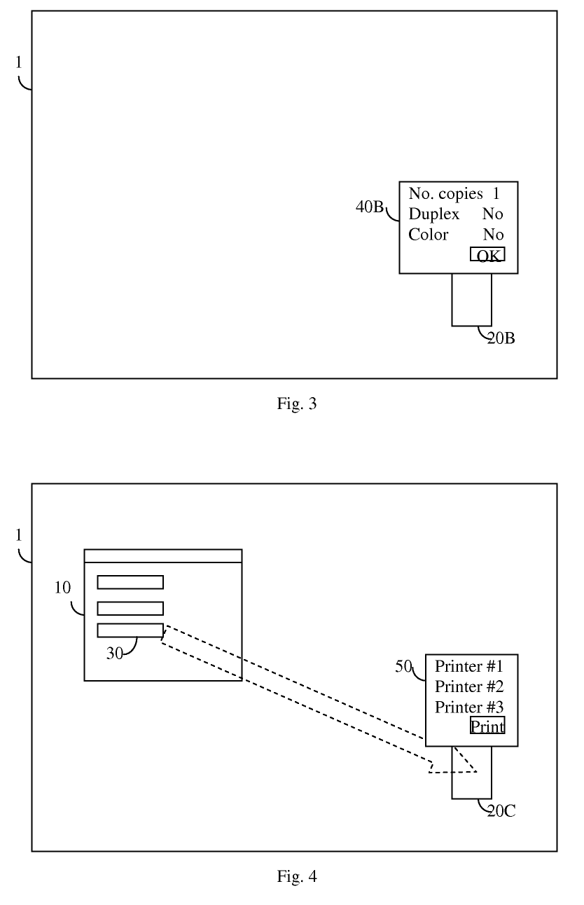

FIG. 3 illustrates a method for changing the printing property settings associated with the printing bin icon according to a second embodiment of the present invention. The printing bin icon 20B allows a user to activate the printing property settings popup menu 40B, such as by right-clicking on the icon 20B. The user may then set the printing property settings displayed in the popup menu 40B. When the user clicks the “OK” button of the popup menu 40B, the printing property settings set in the menu 40B are saved and can be used for subsequent printing using the printing bin icon. If the printing bin icon has more than one printer associated with it, the popup menu 40B will allow the user to set the printing properties of each printer.

It should be noted that the user may also use a normal procedure provided by application programs or the operating system to change and save the printing property settings of an associated printer.

If multiple printers are associated with the printing bin icon, one of them may be set as the default printer. For example, the popup menu 40B in FIG. 3 may include a “set default printer” menu item to allow the user to set one printer as the default printer. In the first embodiment, the files are printed to the default printer.

FIG. 4 illustrates a method of selecting one of the printers associated with the printing bin icon for printing a file according to a third embodiment of the present invention. As shown in FIG. 4, when the user drops a file onto the printing bin icon 20C, a printer selection popup menu 50 is displayed. The menu 50 lists all the printers associated with the printing bin icon that that file can be printed to. The user selects one of the printers from the menu 50, and the file is printed to the selected printer using the currently stored printing property settings of that printer. Preferably, the printer selection is temporary and does not change which printer is set as the default printer.

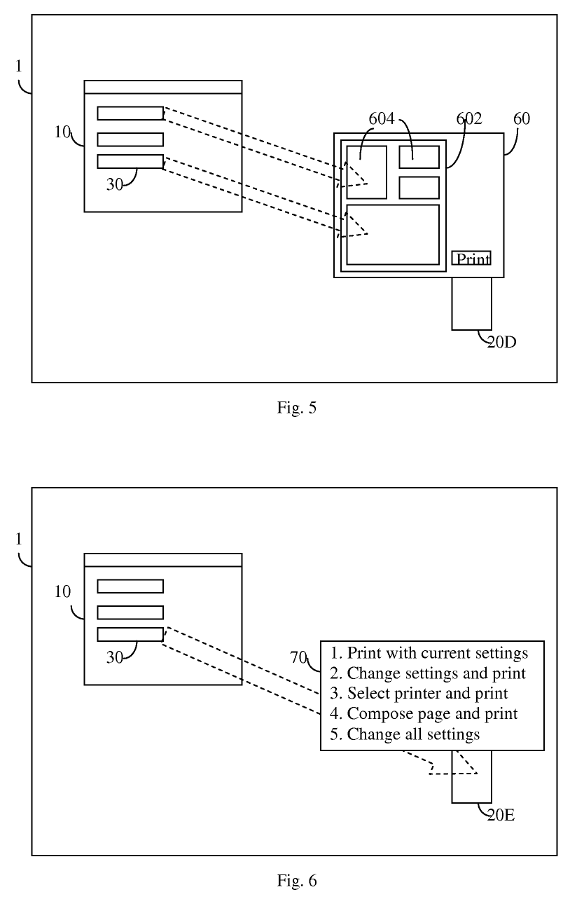

FIG. 5 illustrates a method for composing a page (or pages) of document and printing the composed page according to a fourth embodiment of the present invention. As shown in FIG. 5, when the user drops a file onto the printing bin icon 20D, a page composition popup menu 60 is displayed. The menu 60 displays an indication 602 of a page, and provides tools to allow the user to create and change a page layout having multiple areas 604 within the page 602. The user drags and drops files 30 into the areas 604. If the files do not fit within the assigned areas, subsequent pages may be automatically generated with the same layout. The files may be different types of files. The printing bin program invokes the applications associated with the various types of files, generates a new file representing the composed page, and submits it to the printer for printing.

More specifically, the appropriate automation APIs are invoked to process the multiple files, stretch or shrink the sizes of the print areas and relocate them to different location of the page based on the page layout created by the user. Then the processed data from the multiple files are filtered and combined so that data from different files belonging to the same page are placed on the same page, creating new output pages (the composed pages). The data representing the composed pages are sent to the printer (with proper compression and encoding if necessary). Using this embodiment, the user can create a page layout template and arrange contents from different files to be printed in desired areas on the same page.

In one particular implementation of the fourth embodiment, when the user drops a first file onto the printing bin 20D, the page composition menu 60 is displayed, initially with a page template 602 with one area 604 containing the first file. The user moves and/or resizes the area 604 as desired. The user then drops a second file onto the page template 602, and a second area 604 is displayed within the page template 602 containing the second file. The user may repeat the steps to add more files to the page template.

If the printing bin icon has multiple printers associated with it, printing control such as a round-robin scheduling may be implemented for the printing bin according to a fifth embodiment of the present invention. Fr example, when a first file is dropped into the printing bin to be printed to a first printer, the first file is processed one portion (e.g., with one page in each portion) at a time. If a second file is dropped into the printing bin to be printed to a second printer while the first file has not finished printing, the printing bin processes the second file one portion at a time, and the portions of the first and second files will be scheduled in a round-robin fashion. As a result, if the first file is relatively large and the second file is relatively small, the second file can start printing without waiting for the entire first file to be finished. Round-robin scheduling is well known in the computing art and can be readily implemented by those or ordinary skill in the art.

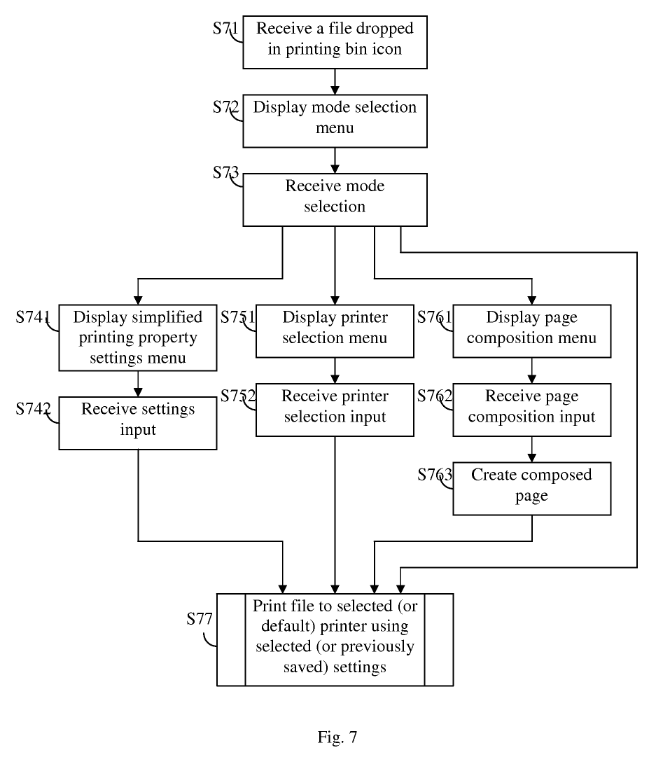

FIG. 6 illustrates a printing method according to a sixth embodiment of the present invention, which allows the user to print a file using the printer bin icon and selecting a printing mode. FIG. 7 is a flow chart illustrating the method flow. As shown in FIGS. 6 and 7, when the user drags and drops a file onto the printing bin icon 20E (step S71), a printing mode selection popup menu 70 is displayed, which lists a number of printing modes (step S72). The user selects one of the printing modes (step S73), and appropriate processing steps for the selected mode are carried out. In the example illustrated in FIGS. 6 and 7, the printing modes and the corresponding processing include:

1. Print with current settings (step S77): The file will be printed to the default printer using the printer's current printing property settings, in a manner similar to conventional drag and drop printing.

2. Change settings and print: If this mode is selected, a printing property settings popup menu such as the menu 40A shown in FIG. 2 will be displayed (step S741) and the user sets the settings (step S742) as described in the first embodiment. The printing bin program prints the file (step S77) using the default printer and the settings received in step S742.

3. Select printer and print: If this mode is selected, a printer selection popup menu such as the menu 50 shown in FIG. 4 will be displayed (step S751) and the user selects a printer (step S752) as described in the third embodiment. The printing bin program prints the file (step S77) using the selected printer.

4. Compose page and print: If this mode is selected, a page composition popup menu such as the menu 60 shown in FIG. 5 will be displayed (step S761) and the user composes a page containing multiple files (step S762) as described in the fourth embodiment. The printing bin program creates a new print job (step S763) and prints the new job (step S77).

5. Change all settings: If this mode is selected, popup menu pages for the various modes above, i.e., change settings and print, select printer and print, and compose page and print, will be displayed sequentially to allow user to perform these functions. In this mode, step S741, S742, S751, S752, S761, S762, S763 and S77 in FIG. 7 will be performed in that order (this branch of the program is not shown in FIG. 7).

Of course, other suitable modes may be implemented.

The printing methods described above may be implemented in a general purpose computer running an operating system and application programs. The printing bin is implemented as an icon style application, i.e., a program represented by an icon that is activated when a file is dragged and dropped onto the icon. Drag and drop operations are supported by the operating system. The various popup menus, the page template, and other UI features used in the various embodiments described above may be implemented using any suitable programming techniques. To implement the printing processes in step S77, APIs offered by various applications (e.g., Microsoft Office Automation, Acrobat Automation) may be used to take control of different type of files and perform printing property setting and page composing without visibly opening the applications associated with the files (e.g., Word, Excel, Access, PowerPoint, Acrobat, Paint, etc.). The applications cooperate with the printer driver programs to perform actual printing of the files. Such implementations are known in the art and have been used in conventional direct printing methods.

It will be apparent to those skilled in the art that various modification and variations can be made in the printing method of the present invention without departing from the spirit or scope of the invention. Thus, it is intended that the present invention cover modifications and variations that come within the scope of the appended claims and their equivalents.

What is claimed is:

1. A method implemented on a computer for printing a file, comprising:
(a) displaying a printing bin icon representing a printing bin program;
(b) in response to a file being dragged and dropped onto the printing bin icon, the printing bin program displaying a printing property settings menu indicating one or more printing property settings for printing the file;
(c) receiving a user input entered via the printing property settings menu for setting the printing property settings; and
(d) printing the file using the printing property settings set in step (c).

2. The method of claim 1, wherein step (d) includes automatically invoking an application associated with the file and a printer driver program.

3. The method of claim 1, wherein the printing property settings menu includes a single screen.

4. The method of claim 1, further comprising:
(e) in response to a second user input associated with the printing bin icon, displaying the printing property settings menu;
(f) receiving a third user input entered via the printing property settings menu for setting the printing property settings; and
(g) store the printing property settings set in step (f).

5. A method implemented on a computer for printing one or more files, comprising:
(a) displaying a printing bin icon representing a printing bin program;
(b) in response to a file being dragged and dropped onto the printing bin icon, the printing bin program displaying a printer selection menu indicating a plurality of printers associated with the printing bin icon;
(c) receiving a user input entered via the printer selection menu for selecting one of the plurality of printers; and
(d) printing the file using the printer selected in step (c).

6. The method of claim 5, wherein step (d) includes automatically invoking an application associated with the file and a printer driver program.

7. The method of claim 5, further comprising:
repeating steps (b) to (d) for a second file,
wherein in step (d) the files are printed using round-robin scheduling.

8. A method implemented on a computer for printing a plurality of files, comprising:
(a) displaying a printing bin icon representing a printing bin program;
(b) in response to one of the plurality of files being dragged and dropped onto the printing bin icon, the printing bin program displaying a page composition menu including a page template;
(c) receiving a user input entered via the page composition menu for forming a composed page, the composed page including one or more areas within the page template, each area containing one of the plurality of files;
(d) generating a new file representing the composed page; and
(e) printing the new file generated in step (d).

9. A method implemented on a computer for printing one or more files, comprising:
(a) displaying a printing bin icon representing a printing bin program;
(b) in response to one of the one or more files being dragged and dropped onto the printing bin icon, the printing bin program displaying a printing mode selection menu including two or more of: a print with current settings mode, a change settings and print mode, a select printer and print mode, and a compose page and print mode;
(c) receiving a first user input entered via the printing mode selection menu selecting one of the printing modes;
(d) displaying a second menu based on the selected printing mode, the second menu being one of a printing property settings menu including one or more printing property settings for printing the file, a printer selection menu including a plurality of printers associated with the printing bin icon, and a page composition menu including a page template;
(e) receiving a second user input entered via the second menu; and
(f) printing the one or more files based on the second user input received in step (e).

10. A computer program product comprising a computer usable medium having a computer readable program code embedded therein for controlling a computer, the computer readable program code configured to cause the computer to execute a printing process, the process comprising:
(a) in response to one of the one or more files being dragged and dropped onto a printing bin icon, displaying a printing mode selection menu including two or more of: a print with current settings mode, a change settings and print mode, a select printer and print mode, and a compose page and print mode;
(b) receiving a first user input entered via the printing mode selection menu selecting one of the printing modes;
(c) displaying a second menu based on the selected printing mode, the second menu being one of a printing property settings menu including one or more printing property settings for printing the file, a printer selection menu including a plurality of printers associated with the printing bin icon, and a page composition menu including a page template;
(d) receiving a second user input entered via the second menu; and
(e) printing the one or more files based on the second user input received in step (d).
